(19) United States
(12) Patent Application Publication
(10) Pub. No.: US 2007/0127513 A1
(43) Pub. Date: Jun. 7, 2007

(54) Starvation reduction in TCP/IP applications

(76) Inventors: Ramesh Sudini, Lake Zurich, IL (US); Carl A. Grube, Vernon Hills, IL (US); Perepa Mahesh, Hyderabad (IN)

Correspondence Address: MOTOROLA INC, 600 NORTH US HIGHWAY 45, ROOM AS437, LIBERTYVILLE, IL, 60048-5343, US

(21) Appl. No.: 11/295,110

(22) Filed: Dec. 6, 2005

(51) Int. Cl. H04L 12/56

(52) U.S. Cl. 370/413

(57) ABSTRACT

A wireless communication device (22) and method provides for the transmission of multiple data streams in a bandwidth-limited environment such that each of the data streams is afforded access to the transmission function in accordance with a priority. The priority may be determined on the basis of the application type, the TCP/IP four-tuple or other means. A data queue may be established during the active duration of each application and may be eliminated when the application has terminated or when the data queue is empty.

### TECHNICAL FIELD

The present application may relate to radio communications systems and more particularly to systems and methods for managing the servicing of multiple data streams in a mobile radio environment.

### BACKGROUND

Technologies are being developed to support data services in mobile environments such as the General Packet Radio Service (GPRS) and Universal Mobile Telecommunications System (UMTS) among other communication protocols. One example of these data services relates to connection through the Internet. Most popular Internet applications such as the World Wide Web (www), file transfer protocol (ftp), and e-mail use the reliable transport service provided by the Transmission Control Protocol (TCP). The performance perceived by users of such applications depends on the performance of the TCP. TCP has been designed and adapted to perform well in traditional wired networks, where data packet losses are assumed to be a symptom of congestion rather than failure in the transmission processes, and where the transmission bandwidth is often sufficient to support a multiplicity of simultaneous applications. Wireless communications systems, however, suffer from handover disconnections, corruption losses, and low and variable bandwidth, which dramatically affects TCP performance.

Transmission Control Protocol (TCP) belongs to the Transport layer of the TCP/IP networking protocol suite. TCP is a connection-oriented protocol that provides a reliable, full-duplex, byte stream for user applications. TCP uses a sliding window protocol for transmitting/receiving data with its peer. The peer is any other device with which communication is being attempted or conducted, at this layer of the protocol, and which has a unique internet protocol (IP) address and port number. A sliding window is based on the advertised “Window Size” of its peer, which is the number of data packets that can be sent without waiting for an acknowledgement (ACK). If there is no congestion in the network, then at anytime after TCP established a connection and determined the size of the appropriate congestion window, the amount of data that TCP has transmitted and waiting for ACK is equal to the window size of the peer or the congestion window, whichever is the lesser.

One problem which arises in a mobile terminal, also referred to as “user equipment” (UE), is starvation of the TCP/IP applications in a multi-application situation due to head-of-the-line (HOL) blocking. The rate at which the TCP/IP data that is queued in a UMTS stack is transmitted out of the UE depends on the data transmission capacity of the physical connection. For example, the radio link between the UE and a base station. In the event of multiple connections or sessions sharing a wireless link, first-in first-out (FIFO) packet scheduling can cause a HOL blocking effect resulting in unfair sharing of bandwidth and effects which may be observable by the human user.

FIG. 1 shows the protocol stacks for packet-domain services in UMTS. For convenience, the protocols for data transmission and reception are divided into three user layers: the first layer L1 including the physical layer (PHY) 10; the second data link layer L2 including the Medium Access Control (MAC) 12, Radio Link Control (RLC) 14, Packet Data-Convergence Protocol (PDCP) 16; and the third layer L3 which includes the network and transport layers for the TCP/IP for each of the user sessions or data flow. Above the TCP/IP protocol layers are the application programs which are the sources and destinations of the data.

The RLC sublayer 14 provides Automatic Repeat Request (ARQ) functionality, transparent data transfer, unacknowledged data transfer, acknowledged data transfer and buffer occupancy. The PDCP 16 functions include: compression in the transmitting entity and decompression in the receiving entity of redundant control information and may include TCP/IP header compression and decompression. Additionally, the PDCP may add control information for each data packet by adding a header.

FIG. 2 illustrates the data processing and data flow in a conventional PDCP/RLC layer. A first using application queues data in a buffer whose size is the lesser of the peer window size and the congestion window for a connection, and this data is passed to the PDCP, which performs header compression 18, if appropriate, and adds PDCP headers 20 so that the data may be correctly associated with the connection or data flow. This data is passed to the RLC as the full size of the data buffer output of the data flow by the TCP/IP, and the contents of the buffer are transmitted by the UE over the radio link at the same time as additional data is being accepted from the TCP/IP data input 13. This is the existing situation and may lead to starvation of one or more applications as previously described. FIG. 3 illustrates a typical situation having one or more mobile UE 22, having an antenna 24, in communication with a base station 26 having an antenna 28. The base station 28 may interface with a data network, such as the Internet 30, having communications paths to other entities acting as servers 32.

### BRIEF DESCRIPTION OF THE DRAWINGS

FIG. 1 shows an example of allocating software functions of a protocol to groups or levels.

FIG. 2 shows a portion of the PDCP uplink functional sublayer of FIG. 1.

FIG. 3 shows a typical radio communications system for data, interconnecting a mobile station with servers through the Internet.

FIG. 4 shows a mobile user equipment device of an embodiment.

FIG. 5 shows details of the PDCP functional sublayer adapted to the embodiment of FIG. 4.

FIG. 6 illustrates steps in a method of establishing and managing queues of the method of FIG. 5.

FIG. 7 illustrates steps in a method for managing the scheduling of queues of the embodiment of FIG. 5.

FIG. 8 illustrates steps in a method for determining the quantity of data in the queues of the PDCP.

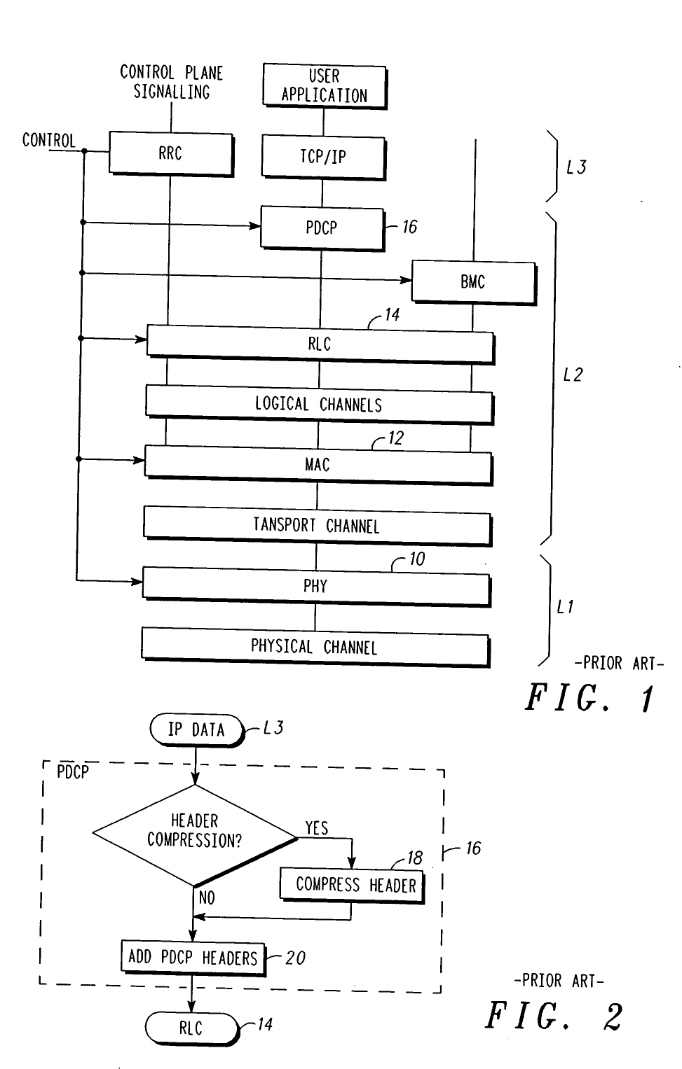

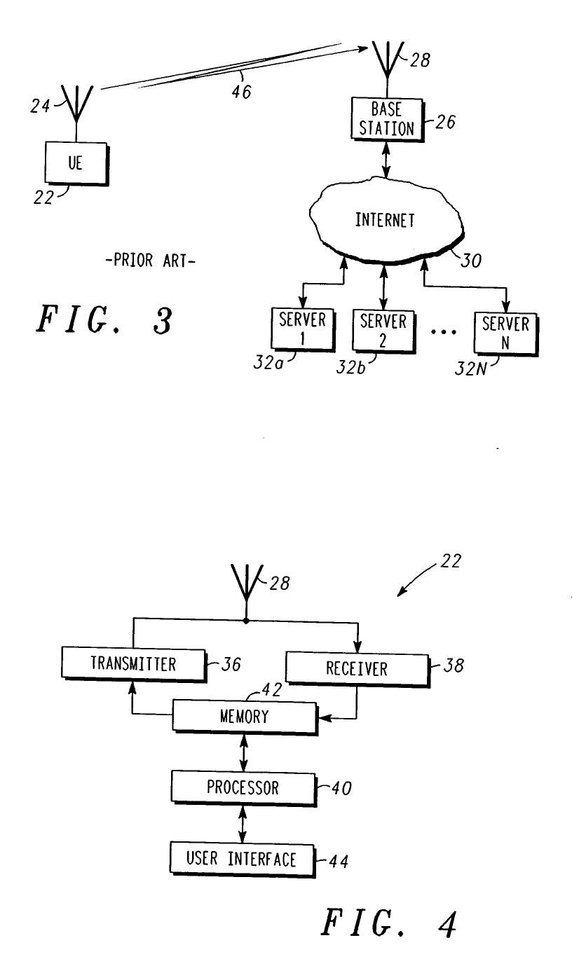

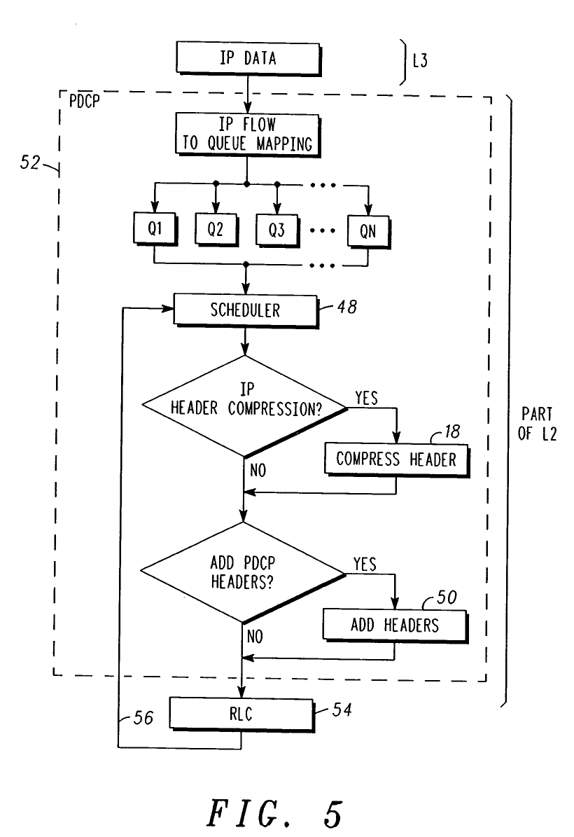

### DETAILED DESCRIPTION

Exemplary embodiments may be better understood with reference to the drawings, but these embodiments are not intended to be limiting. Like numbered elements in the same or different drawings perform equivalent functions.

When a specific feature, structure, or characteristic is described in connection with an embodiment, it will be understood that one skilled in the art may effect such feature, structure, or characteristic in connection with other embodiments, whether or not explicitly stated herein.

Embodiments may be implemented in hardware, firmware, software, or any combination thereof, and may include instructions stored on a machine-readable medium, which may be read and executed by one or more processors. Embodiments are disclosed in the context of a plurality of applications in a client, which may be a mobile communications device, such as a cellular radio, text messaging device or the like, and the protocols are exemplified by, for example, TPC/IP transport and network layer protocols, for convenience, however it is not intended that this be a limitation. Applications mean any software, firmware or hardware implemented functions communicating directly or indirectly with another application, a client or a server. Such applications may include text messaging, audio or video, e-mail and the like, as well as housekeeping functions such as status reporting. Wireless communication means may include, audio, radio, lightwave or other technique not requiring a physical connection between a transmitting device and a corresponding receiving device. While the communication is described as being from a transmitter to a receiver, this does not exclude the reverse path, and a wireless communications device may include both transmitting and receiving functions.

The terms “data queue”, and “buffer” are generally used interchangeably to refer to a one or more readable data elements stored in memory and used to represent the information being processed or being transmitted by an application, a program, an operating system or the like. Buffers may be of any size as measured in computer readable information, and be established, managed and eliminated under the control of a stored program or other similar mechanism, including firmware or hardware.

As shown in FIG. 4, the mobile communications device may be termed user equipment (UE) 22, and may include an antenna 24, a transmitter 36, a receiver 38, a processor 40, memory 42, a user interface 44, a source of power, and the like.

In accordance with the TCP/IP protocol, each active application having a data stream may be represented by a 4-tuple that describes the session connection. At the UE 22, the 4-tuple includes a port number at each of the UE and the peer (source port, destination port). Port numbers may be assigned on an ephemeral or static basis for each application data stream. In certain circumstances applications may be assigned more than one port number. The 4-tuple also includes the IP address of the UE and the peer. The server 32N, or peer, of the UE 22 is reached by traversing a telecommunications network, which may be the Internet 30, after being transmitted over a wireless link 46. At the server 32N, a destination port is associated with the server application being connected to, and is often what is termed a “well known” port number, being designated for convenience in specifying the service required of the server by the UE application (client). The combination of the client port number and client IP address (“first socket”) and the server port number and server IP address (“second socket”) defines a data flow, data stream, session or connection.

In an embodiment, the functionality of the PDCP sublayer of the second protocol layer may be as shown in FIG. 5. Functions such as header compression 18 and the addition of PDCP headers 50 or other data identifiers may not be altered, although these functions may now be associated with individual data flows.

A local flow control 56 is established between the PDCP 52 and the RLC 54. The flow control may be maintained such that the quantity of data in the RLC queue is sufficiently small for the process to be responsive to changes in user application requirements and the activation of new user applications, but sufficiently large as to prevent data starvation at the physical layer 10.

For each active data flow, a queue Qk is dynamically created to store the application data dispatched by the network and transport layers (TCP/IP). Each queue Qk may be established when data associated with unique client port number and server data port number and IP address arrives at the PDCP 52 and there is no preexisting queue for the specific data flow. The queue Qk for the data flow exists until all of the data has been unloaded from the queue. Where the application is transmitting more data than can be accommodated in the associated queue, the queue may be continuously reloaded by the application and TPC/IP protocol such that the queue is maintained until the desired block of data has been transmitted. Alternatively, a fixed queue size is established, and the queue is extinguished when the data has been transmitted. Further data in the data stream results in establishment of a new queue. Where multiple applications are active, there are multiple data flows and therefore multiple queues simultaneously extant.

Data packets are de-queued from each of the queues in accordance with a scheduling algorithm in the scheduler 48, which may be a round-robin scheduler. The size of the data packet may be varied, and either one packet or a multiple of packets de-queued by the scheduler. The de-queued packets are dispatched from the queue Qk to the RLC 54 after an appropriate PDCP header has been applied. Header compression 18 may also be performed.

In an aspect, a packet of data may be the maximum of the actual data to be transmitted and the MTU (maximum transmission unit) of the physical layer 10, including any header and trailer information required by the data protocols. In another aspect, the queue size of each queue associated with a data flow may be set by the maximum of the peer window size or the congestion buffer, whichever is less.

The operation of a round-robin scheduler 48, for a situation where there are two active data steams having associated queues, results in quantity of data (a data block), as described above, being removed from the first queue and dispatched to the RLC 54. The second block to be dispatched is from the second queue, representing the second data stream. The third block is then removed from the first queue. The amount of data remaining in each of the queues may determined by counting the quantity of data being removed from the queue during each execution cycle of the scheduling algorithm and the quantity of data added to the queue during the execution cycle of the scheduler 48, and adjusting the queue data quantity by the difference therebetween. Additionally, the number of active queues QN is determined periodically, so that new queues may be added to those being serviced by the scheduler 48, and empty queues deleted from the servicing process. As the location of queues may be in random access memory 42, the size and location of such queues is determined by an allocation table or other management means, such as memory address pointers. Determination of queue size, quantity and identity may be done on a time periodic basis, a fixed number of scheduler cycles, or multiple times per scheduler cycle. Applications may also be configured to indicate the total amount of data remaining locally to each application which has not as yet been transferred to a queue in the PDCP 52. This may be useful in reporting the total data transmission backlog of the UE when a large amount of data remains to be transmitted.

A round robin scheduler adapts to the number of active queues, representing active data streams, by dispatching a packet from each one of the active queues in turn until all of the queues have been accessed. The sequence is repeated, taking account of the addition and deletion of queues which may have occurred in the interim. Queues may be added or deleted dynamically during each round robin cycle, or at the conclusion of a first round robin cycle before initiation of a second round robin cycle. This process may be performed each time the RLC 54 requests data, and may result in filling the RLC 54 buffer. One round robin cycle may be performed each time the RLC 54 requests data 56; however this may not provide enough data to keep the RLC buffer fully loaded. Consequently, when the RLC 54 requests data the round robin process may be performed until the RLC buffer has been fully loaded, or until a quantity of data specified by the RLC request 56 is loaded into the RLC buffer.

In addition, the RLC 54 may request data from the PDCP 52 to determine the present data loading of the applications. In this example, the PDCP 52 reports the sum of the contents of the existing queues Qn, taking account of the compression and formatting of the data and PDCP headers, and may also include the quantity of data reported by the applications for each active data stream. This may permit the establishment of a local flow control loop with the PDCP 52 with the requests for data 56 from the PDCP layer being regulated by the data transmission capacity of the physical layer 10. In reporting the loading of the UE to a network device, either autonomously or as the result of a poll, the buffer occupancy measure may take account of the contents of the RLC buffer as well as the PDCP and application buffers.

Although the functions have been described in accordance with a three level protocol stack, the allocation of the functions described to a specific layer of position within the protocol is not intended to be limiting as it will be evident to a person skilled in the art that such functions may be moved between functional or protocol layers without departing from the teachings herein.

In another example, the scheduler 48 may differ from a round robin algorithm in order to effect a prioritization of the emptying of the queues, based on design criteria related to the quality of service to be allocated to each of the applications and associated data streams. Such an allocation may be based on multiple criteria, and may be dynamically altered. Examples of such criteria are: user perception of delay in service, criticality of data for safety, and the like.

A method for managing data flows in a wireless communications system may include providing a TCP/IP protocol to configure data from one or more applications into data flows, transferring data blocks from each active application program data stream to a corresponding data queues and maintaining the data queues, and a scheduling algorithm to transfer data from the data queues to an output buffer, in accordance with a data request from the output buffer.

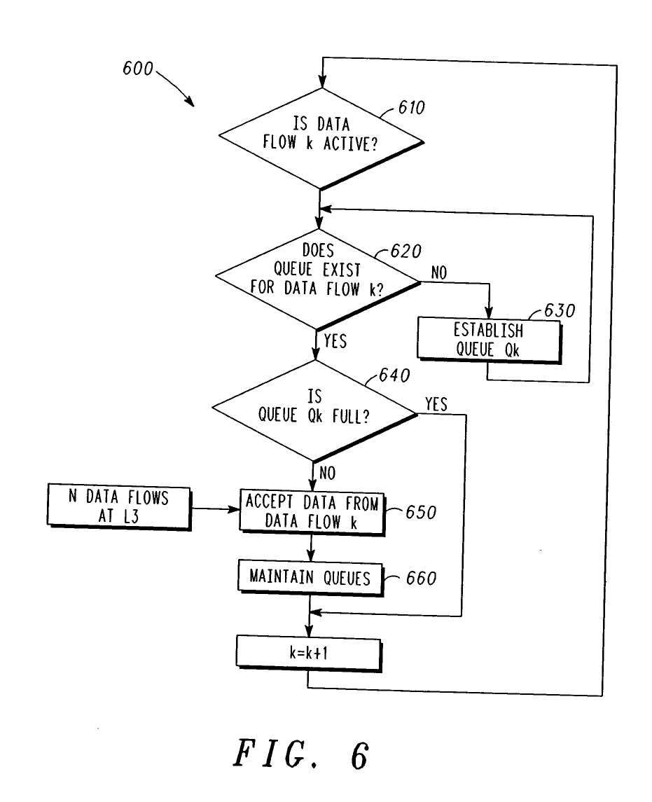

In an example, shown in FIG. 6, a method of data queue maintenance 600 may include sequentially examining each data queue to determine if the associated data flow is active 610, confirming that a corresponding data queue Qk exists 620, establishing a data queue if no data queue exists 630, determining if data queue Qk is full 640, accepting data from the active data flow into the queue Qk until the queue has been filled 650, and maintaining the queues 660, including deleting or re-assigning queues when a data stream either has no data or has been terminated.

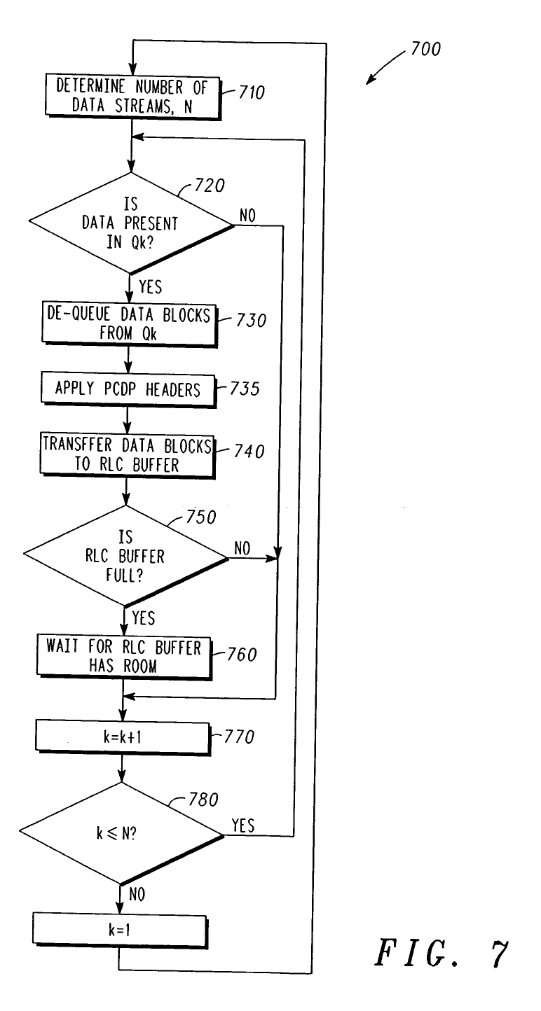

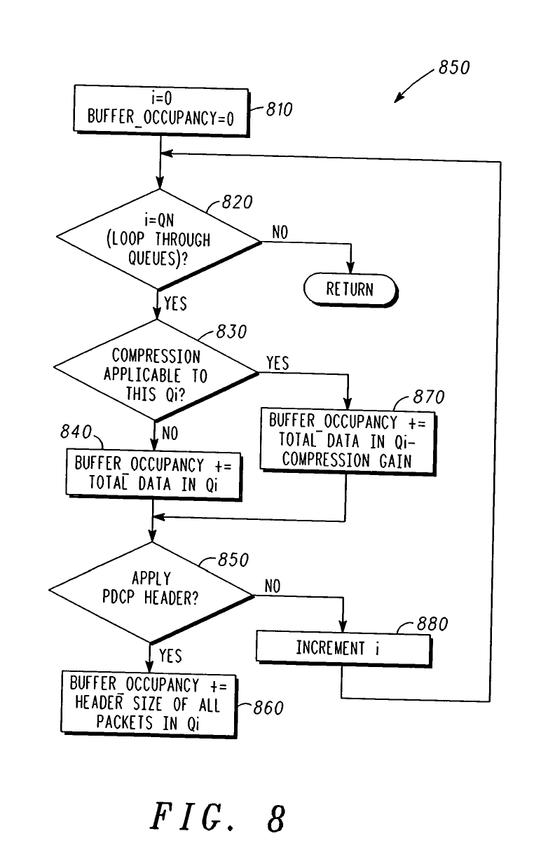

In another example, shown in FIG. 7, a method of scheduling may include transferring data blocks from the data queues Qk, by determining the number of active data queues N 710, determining if data blocks remain in data queue Qk 720, de-queuing M blocks of data from the queue Qk 730, applying the PDCP functionality, such as headers 735, and transferring the M blocks of data to the RLC 740, determining if the RLC buffer is full 750, if the RLC buffer is full, waiting until sufficient room is available to be able to transfer more data 760, incrementing the buffer counter if sufficient room exists in the RLC buffer 770, continuing to increment through successive buffers until the N data queues have been scanned 780, and, repeating the process 770.

A method 800 of computing the amount of data present in the plurality of data queues Qn is shown in FIG. 8. The method includes initializing a counter to zero 810 at the beginning of a scan of the N currently established queues, scanning each queue Qi sequentially 820 and determine if compression of the data is appropriate 830 for the present queue, if no compression is to be performed, the total buffer occupancy is the occupancy of queue Qi added to the previous value of total buffer occupancy (shown by the C programming symbol “+=”) 840. If no PDCP header is applied then the result at step 840 represents the total buffer occupancy for all of the queues less than or equal to Qk. The queue number is incremented 880 and the scan continues until all N queues are scanned. However, if at step 830 it is determined that compression is applicable to this queue, the buffer occupancy is determined by reducing the value representing the data in queue Qk by the effect of data compression 870 prior to adding the value to the previous value. Similarly, if headers are to be added to the data in queue Qk, then the header size of all of the packets in queue Qk is added to the previous value of buffer occupancy 860. When all of the queues QN have been scanned, the value of buffer occupancy represents the total amount of data present in the data buffers that is ready to be transmitted. Depending on the reporting protocol, this value of data may be added to the current occupancy of the RLC buffer, and may also incorporate buffer occupancy values form user applications.

Schedulers may have algorithm attributes where the size M of the block of data removed from a queue Qk may depend on the priority established for the queue, or the queue may be serviced more than once per scheduler cycle or less than once per cycle. The priority may also relate to the amount of data remaining in the queue and in the application buffer.

Although this description has been approached from the viewpoint of the UE it will be appreciated that a similar approach may be adopted at the other end of a radio link for the return path, and such a return link may provide for connections to a number of UE, each UE having a number of active data steams.

The present invention has been explained by way of the examples described above; however, it should be understood to the ordinary skilled person in the art that the invention is not limited to the examples, but rather that various changes or modifications thereof are possible without departing from the spirit of the invention. Accordingly, the scope of the invention shall be determined only by the appended claims and their equivalents.

What is claimed is:

1. A portable wireless apparatus, comprising:
a processor;
an input data buffer associated with a data stream;
an output data buffer communicating with a radio transmitter; and,
a scheduler to maintain a data queue in the output data buffer.

2. The apparatus according to claim 1, wherein the scheduler is operable in conjunction with the processor and configured to transfer data from the input data buffer to the output data buffer.

3. The apparatus according to claim 1, wherein a number of input data buffers is at least equal to a number of active applications.

4. The apparatus according to claim 1, further comprising an output data buffer manager to request a quantity of data from the scheduler.

5. The apparatus according to claim 1, wherein the data stream is characterized by a source address and port number and a destination address and port number.

6. The apparatus according to claim 1, wherein the data stream is associated with a user application.

7. The apparatus of claim 6, wherein a plurality of data streams are associated with each user application.

8. The apparatus of claim 1, wherein at least one of the input data buffer or the output data buffer are first-in-first-out (FIFO) buffers.

9. The apparatus of claim 1, wherein the scheduler is a round-robin scheduler.

10. A method in a wireless communication device, the method comprising:
forming an input data queue having blocks of data, the input data queue associated with a data stream; and, when a plurality of input data queues exist;
transferring blocks of data from the plurality of input data queues to an output data queue using a scheduling process; and
transmitting the contents of the output data queue.

11. The method of claim 10, wherein the scheduling process comprises:
determining if an output data queue has requested data blocks;
wherein, if the output data queue has requested data blocks:
a quantity of data comprising one or more data blocks is transferred from each input data queue to the output buffer, such that the quantity of data is transferred from each of the plurality of input data queues before a second quantity of data is transferred from any of the input data queues, until either the request for data blocks is satisfied, or the output data queue is full.

12. The method of claim 11, further comprising the step of associating blocks of data from an application with the input data queue, the data blocks being characterized by a source address and port number and a destination address and port number.

13. The method of claim 12, wherein the scheduling process assigns a priority to the queue based on the source address and port number and the destination address and port number of the data blocks.

14. The method of claim 13, wherein the quantity of data blocks transferred from the input data queue to the output data queue is related to the priority.

15. The method of claim 14, wherein the quantity of blocks is a null.

16. The method of claim 10, wherein a value representing the number of data blocks or data bytes remaining to be transmitted is determined and reported.

17. The method of claim 16, wherein the value represents the number of data blocks or data bytes in a total number of queues.

18. The method of claim 17, wherein the value represents the number of data blocks or data bytes taking into consideration the protocol overhead and compression in that protocol layer.

19. The method of claim 10, wherein the data blocks are compressed prior to transfer to the output data buffer.

20. A wireless communication device, comprising:
a data block queue having associated source and destination address and port information;
a scheduler having an input and an output, the data block queue coupled to the scheduler input, the scheduler ordering data blocks based on the source and destination address and port information, and the ordered data blocks output at the scheduler output; and
a transmitter coupled to the scheduler output.

21. The device of claim 20, further comprising:
at least one application running on the wireless communication device; and
a data block output of the application coupled to the data block queue;
wherein each block output includes a corresponding source protocol address, source port number, destination protocol address, and destination port number.

22. The device of claim 21, further comprising:
a plurality of applications running on the wireless communication device, data block outputs of the applications coupled to the data block queue,
ordering the data blocks based on the application from which the data blocks originate.

23. The method of claim 20, further comprising a compression entity coupled to the scheduler output, the compression entity compressing the blocks of data and adding protocol overhead after ordering the blocks of data, an output of the compression entity coupled to the transmitter.
